(19) United States
(12) Patent Application Publication
(10) Pub. No.: US 2026/0161923 A1
(43) Pub. Date: Jun. 11, 2026

(54) MULTI-TASK FACIAL BEAUTY PREDICTION METHOD, APPARATUS, DEVICE, AND MEDIUM

(71) Applicant: WUYI UNIVERSITY, Jiangmen (CN)

(72) Inventors: Junying GAN, Jiangmen (CN); Junling XIONG, Jiangmen (CN); Heng LUO, Jiangmen (CN); Xiaoshan XIE, Jiangmen (CN); Huicong LI, Jiangmen (CN); Jianqiang LIU, Jiangmen (CN)

(21) Appl. No.: 18/710,402

(22) PCT Filed: May 22, 2023
(86) PCT No.: PCT/CN2023/095557

§ 371 Date: May 15, 2024

(30) Foreign Application Priority Data
May 11, 2023 (CN) 202310533611.1

(51) Int. Cl. G06V 10/776; G06V 10/40; G06V 10/72; G06V 10/764; G06V 10/82; G06V 10/96; G06V 40/16

(52) U.S. Cl. CPC G06N 3/045; G06N 3/096; G06V 10/72; G06V 10/764; G06V 10/82; G06V 10/40; G06V 40/168

(57) ABSTRACT

A multi-task facial beauty prediction method and apparatus, device, and medium are disclosed. The method includes: training a multi-task teacher model according to a facial image to obtain a first model; performing regularization on the first model according to a beauty grade label and a noise label to obtain a second model; performing cooperative teaching on a plurality of second models to obtain a target model parameter; substituting the target model parameter into a multi-task student model to obtain the target model; and performing facial beauty prediction processing using the target model to obtain a facial beauty prediction result.

### CROSS-REFERENCE TO RELATED APPLICATIONS

This application is a national stage filing under 35 U.S.C. § 371 of international application number PCT/CN2023/095557, filed May 22, 2023, which claims priority to Chinese patent application No. 202310533611.1 filed May 11, 2023. The contents of these applications are incorporated herein by reference in their entirety.

### TECHNICAL FIELD

Embodiments of the present disclosure relate to, but are not limited to, the field of image recognition, and in particular to a multi-task facial beauty prediction method, apparatus, device, and medium.

### BACKGROUND

Current facial beauty prediction methods typically require a large amount of labeled data for model training. However, in the process of labelling noise samples, the quality of labels may be affected by subjective factors, as well as technical aspects of the tools used, such as human or machine labelling, resulting in label noises. The problem of label noises will greatly affect the accuracy of the model and reduce the effect of facial beauty prediction.

### SUMMARY

The following is a summary of the subject matter detailed herein. This summary is not intended to limit the scope of the claims.

Embodiments of the present disclosure aim to solve at least one of the technical problems in the existing technology, and the embodiments of the present disclosure provide a multi-task facial beauty prediction method, apparatus, device, and medium, which can improve the accuracy of facial beauty prediction.

According to an embodiment of a first aspect of the present disclosure, a multi-task facial beauty prediction method includes:
acquiring a facial image;
training a multi-task teacher model according to the facial image to obtain a first model, where the multi-task model includes a shared feature network layer for extracting shared features and a plurality of independent feature network layers for extracting different specific features;
performing regularization on the first model according to a beauty grade label and a noise label of the facial image to obtain a second model;
performing cooperative teaching on a plurality of second models to obtain a target model parameter;
substituting the target model parameter into a multi-task student model to obtain a target model; and
performing facial beauty prediction processing using the target model to obtain a facial beauty prediction result.

According to some embodiments of the first aspect of the present disclosure, the facial image includes a plurality of types of facial beauty-related data; the training a multi-task teacher model according to the facial image to obtain a first model includes:
inputting the plurality of types of facial beauty-related data into the shared feature network layer for feature extraction to obtain the shared features;
inputting the plurality of types of facial beauty-related data into the respective independent feature network layers for feature extraction to obtain a plurality of corresponding specific features; and
respectively inputting the shared features and the plurality of specific features into a plurality of task network layers of the multi-task teacher model to obtain a plurality of corresponding task output results to train the multi-task teacher model to obtain the first model.

According to some embodiments of the first aspect of the present disclosure, the performing regularization on the first model according to a beauty grade label and a noise label of the facial image to obtain a second model includes:
training the first model according to the facial image having the beauty grade label to obtain a basic model;
training the first model according to the facial image having the noise label to obtain a noise model;
reversely updating a parameter of the basic model according to a loss function of the noise model; and
performing regularization on the basic model with updated parameter to obtain the second model.

According to some embodiments of the first aspect of the present disclosure, the performing regularization on the basic model with updated parameter to obtain the second model includes:
adding a softmax layer to the basic model with updated parameter;
providing a layer weight value and a bias value to an output of the basic model to which the softmax layer is added;
performing dropout regularization on the output of the basic model to which the layer weight value and the bias value is provided to obtain a target output;
obtaining a target loss function of the basic model according to the target output and the first loss function; and
optimizing the parameter of the basic model according to the target loss function to obtain a second model.

According to some embodiments of the first aspect of the present disclosure, the first loss function is a cross-entropy loss function.

According to some embodiments of the first aspect of the present disclosure, the plurality of second models comprise two second models; the performing cooperative teaching on a plurality of second models to obtain a target model parameter includes:
determining first samples according to one of second networks, where the first samples are samples with a clean probability greater than a pre-set probability when the one of second networks performs feed-forward selection;
determining second samples according to the other one of the second networks, where the second samples are samples with a clean probability greater than a pre-set probability when the other one of the second networks performs feed-forward selection;
selecting third samples from the first samples according to a small loss criterion, where a proportion of the number of the third samples to the number of the first samples is a pre-set proportion;
selecting fourth samples from the second samples according to the small loss criterion, where a proportion of the number of the fourth samples to the number of the second samples is a pre-set proportion;
training the one of second networks via the fourth samples to obtain a first model parameter, and training the other one of the second networks via the third samples to obtain a second model parameter; and
obtaining a target model parameter according to the first model parameter and the second model parameter.

According to some embodiments of the first aspect of the present disclosure, the pre-set proportion is related to a forgetting rate of the second models.

According to an embodiment of a second aspect of the present disclosure, a facial beauty prediction apparatus includes:
an input unit, configured to acquire a facial image;
a model training unit, configured to train a multi-task teacher model according to the facial image to obtain a first model, where the multi-task model includes a shared feature network layer for extracting shared features and a plurality of independent feature network layers for extracting different specific features;
a regularization unit, configured to perform regularization on the first model according to a beauty grade label and a noise label of the facial image to obtain a second model;
a cooperative teaching unit, configured to perform cooperative teaching on a plurality of second models to obtain a target model parameter, and to substitute the target model parameter into a multi-task student model to obtain a target model; and
a prediction unit, configured to perform facial beauty prediction processing using the target model to obtain a facial beauty prediction result.

According to an embodiment of the third aspect of the present disclosure, an electronic device includes a memory, a processor, and a computer program stored on the memory and executable on the processor, where the processor, when executing the computer program, implements the multi-task facial beauty prediction method as described above.

According to an embodiment of a fourth aspect of the present disclosure, a computer-readable storage medium is provided, which has computer-executable instructions stored thereon for performing the multi-task facial beauty prediction method as described above.

The above solutions have at least the following beneficial effects. Feature compression can be achieved by regularization, and the training process can be optimized to weaken the effect of bias terms related to over-fitting. In combination with cooperative teaching, it can further prevent the network from over-fitting the noise labels, and reduce the negative impact of noise labels on facial beauty prediction network. Based on multi-task training, the model framework is established, and the model parameter is shared by supervising information of multiple related tasks, to effectively improve the learning ability and prediction accuracy of the model. The robustness of the model to noise and the generalization ability of the model are significantly improved, thus improving the accuracy of facial beauty prediction.

### BRIEF DESCRIPTION OF DRAWINGS

The accompanying drawings, which are included to provide a further understanding of the present disclosure and are incorporated in and constitute a part of the description, illustrate embodiments of the present disclosure and together with the description serve to explain the principles of the present disclosure and are not intended to limit the scope of the present disclosure.

FIG. 1 is a flowchart of a multi-task facial beauty prediction method provided according to an embodiment of the present disclosure;

FIG. 2 is a sub-step diagram of step S300;

FIG. 3 is a sub-step diagram of step S340;

FIG. 4 is a sub-step diagram of step S400;

FIG. 5 is a structural diagram of a facial beauty prediction apparatus according to an embodiment of the present disclosure.

### DETAILED DESCRIPTION

In order to make the objectives, technical solutions and advantages of the present disclosure clearer and understandable, the present disclosure is further described in detail below in conjunction with the accompanying drawings and embodiments. It should be understood that the specific embodiments described herein are for the purpose of explaining the present disclosure only and are not intended to limit the present disclosure.

It will be appreciated that although the division of functional modules is illustrated in a schematic diagram of an apparatus and a logical sequence is illustrated in a flowchart, in some cases, the steps illustrated or described may be performed in an order different from that of the division of modules in the apparatus or the sequence in the flowchart. The terms “first”, “second”, etc. in the description, the claims, or the above figures are used to distinguish similar objects, rather than to describe a particular order or sequence.

The embodiments of the present disclosure are further described below with reference to the accompanying drawings.

The embodiments of the present disclosure provide a multi-task facial beauty prediction method.

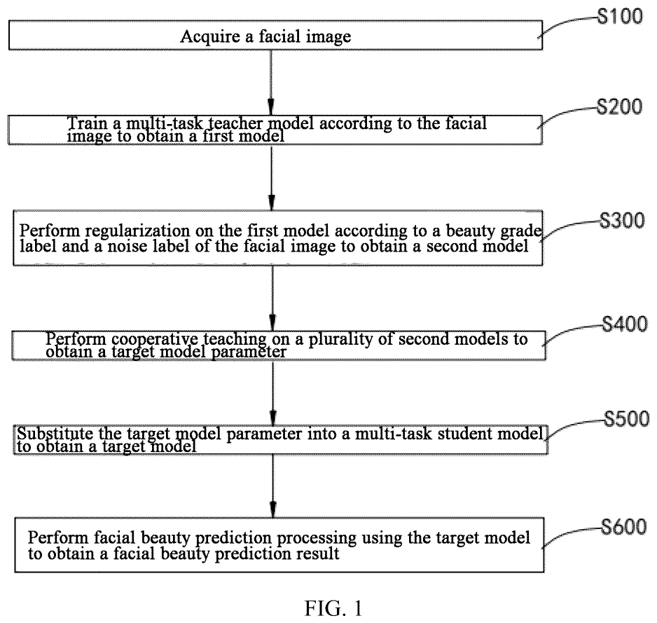

Referring to FIG. 1, the multi-task facial beauty prediction method includes, but is not limited to, the following steps:
step S100: acquiring a facial image;
step S200: training a multi-task teacher model according to the facial image to obtain a first model;
step S300: performing regularization on the first model according to a beauty grade label and a noise label of the facial image to obtain a second model;
step S400: performing cooperative teaching on a plurality of second models to obtain a target model parameter;
step S500: substituting the target model parameter into a multi-task student model to obtain a target model; and
step S600: performing facial beauty prediction processing using the target model to obtain a facial beauty prediction result.

In this embodiment, feature compression can be achieved by regularization, the training process can be optimized to weaken the effect of bias terms related to over-fitting. In combination with cooperative teaching, it can further prevent the network from over-fitting the noise labels, and reduce the negative impact of noise labels on facial beauty prediction network. Based on multi-task training, the model framework is established, and the model parameter is shared by supervising information of multiple related tasks, to effectively improve the learning ability and prediction accuracy of the model. The robustness of the model to noise and the generalization ability of the model are significantly improved, thus improving the accuracy of facial beauty prediction.

With regard to step S100, the facial image may be acquired through an external database, such as a Large-scale Asia Facial Beauty Database (LSAFBD) and a SCUT-FBP5500 database. The facial image is used to train a network model.

In addition, it is necessary to preprocess the facial image, for example, to perform image transformation and correction, image enhancement, etc.

The facial image is normalized and standardized by image preprocessing, which is beneficial to the subsequent model training.

The facial image includes a plurality of types of facial beauty-related data, such as gender data and facial beauty data.

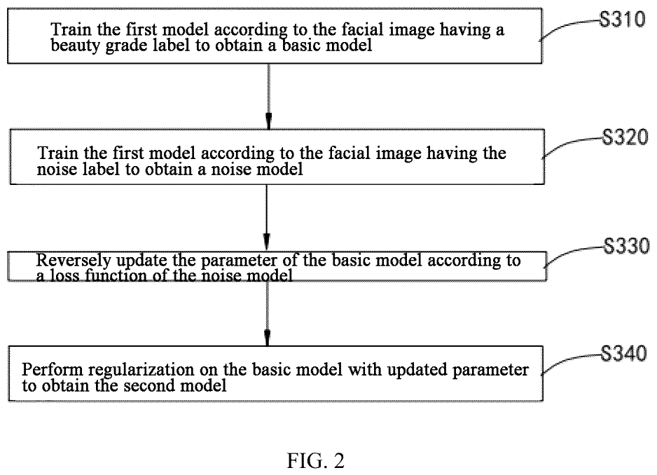

Referring to FIG. 2, with regard to step S200, the raining a multi-task teacher model according to a facial image to obtain a first model includes, but is not limited to, the following steps:
step S210: inputting the plurality of types of facial beauty-related data into a shared feature network layer for feature extraction to obtain shared features;
step S220: inputting the plurality of types of facial beauty-related data into the corresponding independent feature network layers for feature extraction to obtain a plurality of corresponding specific features; and
step S230: respectively inputting the shared features and the plurality of specific features into a plurality of task network layers of the multi-task teacher model to obtain a plurality of corresponding task output results to train the multi-task teacher model to obtain the first model.

The multi-task model includes a shared feature network layer for extracting shared features, a plurality of independent feature network layers for extracting different specific features, and a plurality of task network layers. Each of the plurality of task network layers is connected to a respective one of a plurality of independent feature network layers.

In the related tasks of facial beauty prediction, such as beauty prediction based on facial beauty data and gender prediction based on gender data, there are features of similar task data, and multi-task learning network can be used, which enables multiple task features to mutually promote learning and predict multiple tasks simultaneously.

The parameter of the shared feature network layer is shared uniformly among different tasks. The parameters at the independent feature network layers are independent of each other, which effectively reduces the risk of model over-fitting.

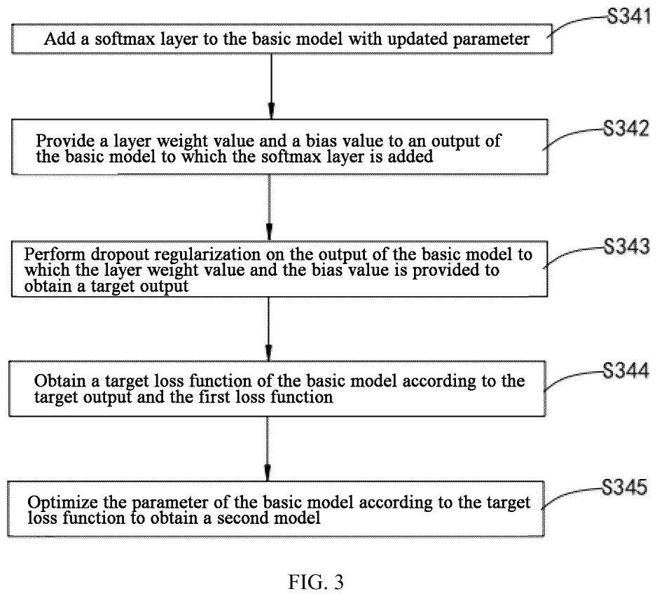

Referring to FIG. 3, with regard to step S300, the performing regularization on the first model according to a beauty grade label and a noise label of the facial image to obtain a second model includes, but is not limited to, the following steps:
step S310: training the first model according to the facial image having a beauty grade label to obtain a basic model;
step S320: training the first model according to the facial image having the noise label to obtain a noise model;
step S330: reversely updating the parameter of the basic model according to a loss function of the noise model; and
step S340: performing regularization on the basic model with updated parameter to obtain the second model.

For n facial images, the facial images are represented by xᵢ, i∈n; the beauty grade labels of the facial images are expressed by yᵢ∈{1, . . . , C}, and the training set of the facial images having the beauty grade label can be expressed as D={(x₁, y₁),(x₂,y₂), . . . , (xₙ, yₙ)}. The noise labels are represented by yᵢ′, and the training set of facial images with the noise label can be represented as

$${D}^{′} = \{ ( {x}_{1} , {y}_{1}^{′} ) , ( {x}_{2} , {y}_{2}^{′} ) , … , ( {x}_{n} , {y}_{n}^{′} ) \} .$$

With regard to step S310, the first model is trained using the facial images having the beauty grade label yᵢ to obtain the basic model, so that the basic model includes a vector θ The vector θ contains a layer weight value and a bias value.

With regard to step S320, the first model is trained using the facial images with the noise label

$${y}_{i}^{′}$$

to obtain a noise model Z.

For step S330, the parameter of the basic model is updated inversely according to the loss function L₂ of the noise model.

With regard to step S340, the performing regularization on the basic model with updated parameter to obtain the second model includes, but is not limited to, the following steps:
step S341: adding a softmax layer to the basic model with updated parameter;
step S342: providing a layer weight value and a bias value to an output of the basic model to which the softmax layer is added;
step S343: performing dropout regularization on the output of the basic model to which the layer weight value and the bias value is provided to obtain a target output;
step S344: obtaining a target loss function of the basic model according to the target output and the first loss function; and
step S345: optimizing the parameter of the basic model according to the target loss function to obtain a second model.

Specifically, the softmax layer is added to an output end of the basic model with updated parameter, the layer weight value W and the bias value h are provided to the output of the basic model with the softmax layer added, dropout regularization processing is performed on the output of the softmax layer to obtain a target output \dot{σ}(h), a target loss function of the model is obtained according to the target output \dot{σ}(h) using a cross-entropy loss function, and a second model is obtained by optimizing the parameter of the basic model according to the target loss function.

The above process can be represented by the following equation:

$$σ ( {z}_{i} ) = Soft max ( {z}_{i} ) = \frac{{e}^{{z}_{i}}}{{\sum }_{1}^{N} {e}^{{z}_{N}}}$$

$$g = σ ( Wh )$$

$$a : Bern ( q )$$

$$\dot{σ} ( h ) = ae σ ( h )$$

$${L}_{dropout} = - \frac{1}{n} {\sum }_{i = 1}^{n} log ( [ σ ( W \cdot \dot{σ} ( h ) ) \text{?} )$$

$$\text{?} \text{indicates text missing or illegible when filed}$$

where zᵢ is an output value of an i^{th} output node of the softmax layer of the basic model, N is the number of output nodes, Bern(q) is a Bernoulli distribution, a is a random variable, and e is a Hadamard product.

With regard to step S400, generally, cooperative teaching is performed on the two second models. One second network is h₁, and the other second network is h₂. Cooperative teaching is that for two networks with the same architecture, one network selects its own mini-batch samples to its peer-to-peer network, and performs cooperative teaching with small loss criterion to update the parameter.

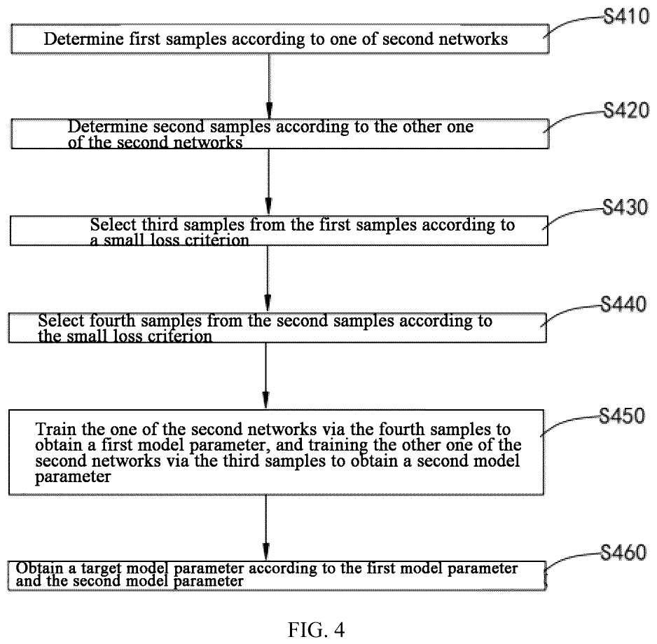

With reference to FIG. 4, the performing cooperative teaching on a plurality of second models to obtain a target model parameter includes, but is not limited to, the following steps:
step S410: determining first samples according to one of second networks;
step S420: determining second samples according to the other one of the second networks;
step S430: selecting third samples from the first samples according to a small loss criterion;
step S440: selecting fourth samples from the second samples according to the small loss criterion;
step S450: training the one of the second networks via the fourth samples to obtain a first model parameter, and training the other one of the second networks via the third samples to obtain a second model parameter; and
step S460: obtaining a target model parameter according to the first model parameter and the second model parameter.

With regard to step S410, the network h₁ selects mini-batch samples D₁ as the first samples, where the first samples are samples with a clean probability greater than a pre-set probability when the one of the second networks performs feed-forward selection, and the first samples may be clean samples or unclean samples.

With regard to step S420, the network h₂ selects mini-batch samples D₂ as the second samples, where the second samples are samples with a clean probability greater than a pre-set probability when the other one of the second networks performs feed-forward selection, and the second sample may be clean samples or unclean samples.

With regard to step S430, in the first samples D₁, sample selection is performed in proportion R(T) according to a small loss criterion to obtain third samples D̅₁̅. The proportion of the number of the third samples to the number of the first samples is a pre-set proportion R(T). Step S430 may be represented by the following equation:

$${\overline{D}}_{1} = arg min {D}_{1}^{′} : \vert {D}_{1}^{′} \vert \geq R ( T ) \vert {D}_{1} \vert L ( {h}_{1} , {D}_{1}^{′} ) .$$

With regard to step S440, in the second samples D₂, sample selection is performed in proportion R(T) according to a small loss criterion to obtain fourth samples D̅₂̅. The proportion of the number of the fourth samples to the number of the second samples is a pre-set proportion R(T). Step S440 may be represented by the following equation:

$${\overline{D}}_{2} = arg min {D}_{2}^{′} : \vert {D}_{2}^{′} \vert \geq R ( T ) \vert {D}_{2} \vert L ( {h}_{2} , {D}_{2}^{′} ) .$$

For step S450, the third samples D̅₁̅ are sent to the network h₂ for training and the parameter ω₂ of the network h₂ is updated, and the fourth samples D̅₂̅ are sent to the network h₁ for training and the parameter ω₁ of the network h₁ is updated. Step S450 may be represented by the following equation:

$${ω}_{1} = {ω}_{1} - η ∇ L ( {h}_{1} , {\overline{D}}_{2} ) , {ω}_{2} = {ω}_{2} - η ∇ L ( {h}_{2} , {\overline{D}}_{1} ) .$$

η is a learning rate.

Specifically, the pre-set proportion is related to the forgetting rate of the second model, and the pre-set proportion may be expressed by the following equation:

$$R ( T ) = 1 - {λ}_{forget} .$$

λ_{forget} is the forgetting rate of the second model.

With regard to step S500, the target model parameter is substituted into the multi-task student model to obtain the target model. The multi-task student model has the same architecture as the multi-task teacher model.

With regard to step S600, facial beauty prediction processing is performed using the target model to obtain a facial beauty prediction result.

An embodiment of the present disclosure provides a facial beauty prediction apparatus.

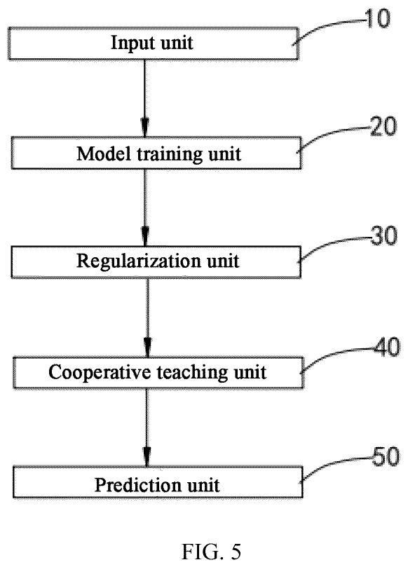

Referring to FIG. 5, the facial beauty prediction apparatus includes: an input unit 10, a model training unit 20, a regularization unit 30, a cooperative teaching unit 40, and a prediction unit 50.

The input unit 10 is configured to acquire a facial image. The model training unit 20 is configured to train a multi-task teacher model according to the facial image to obtain a first model, where the multi-task model includes a shared feature network layer for extracting shared features and a plurality of independent feature network layers for extracting different specific features. The regularization unit 30 is configured to perform regularization on the first model according to a beauty grade label and a noise label of the facial image to obtain a second model. The cooperative teaching unit 40 is configured to perform cooperative teaching on a plurality of second models to obtain a target model parameter, and to substitute the target model parameter into a multi-task student model to obtain a target model. The prediction unit 50 is configured to perform facial beauty prediction processing using the target model to obtain a facial beauty prediction result.

It can be understood that the facial beauty prediction apparatus in the present embodiment uses the above-mentioned multi-task facial beauty prediction method, and each unit of the facial beauty prediction apparatus in the present embodiment corresponds to a respective step of the above-mentioned multi-task facial beauty prediction method, solves the same technical problem as the above-mentioned multi-task facial beauty prediction method, and has the same beneficial effects as the above-mentioned multi-task facial beauty prediction method.

According to an embodiment of the present disclosure, an electronic device is provided, which includes a memory, a processor, and a computer program stored on the memory and executable on the processor, where the processor, when executing the computer program, implements the multi-task facial beauty prediction method as described above.

The electronic device may be any intelligent terminal including a tablet computer, a vehicle-mounted computer, etc.

In general, with regard to the hardware structure of the electronic device, the processor may be implemented in the form of a general Central Processing Unit (CPU), a microprocessor, an Application Specific Integrated Circuit (ASIC), or one or more integrated circuits to execute the relevant programs to implement the technical solutions provided by the embodiments of the present disclosure.

The memory may be implemented in the form of a Read Only Memory (ROM), a static storage device, a dynamic storage device, or a Random Access Memory (RAM). The memory may store an operating system and other application programs, and when the technical solutions provided by the embodiments of the present description are implemented by software or firmware, the relevant program codes are stored in the memory and are called by the processor to execute the method of the embodiments of the present disclosure.

The input/output interface is configured to achieve information input and output.

The communication interface is configured to achieve communicative interaction between the device of the present disclosure and other devices, and can realize communication in a wired mode (such as USB, network cable, etc.), and can also achieve communication in a wireless mode (such as mobile network, WIFI, Bluetooth, etc.).

The bus conveys information between various components of the device, such as the processor, the memory, the input/output interfaces, and the communication interface. The processor, the memory, the input/output interface, and the communication interface are communicatively coupled to each other within the device via the bus.

According to an embodiment of the present disclosure, a computer-readable storage medium is provided, which has computer-executable instructions stored thereon for performing the multi-task facial beauty prediction method as described above.

It will be appreciated that the method steps in the embodiments of the present disclosure may be implemented or performed by computer hardware, a combination of hardware and software, or by computer instructions stored on non-transitory computer-readable memory. The method may use standard programming techniques. Each program may be implemented in a high-level procedural or object-oriented programming language to communicate with a computer system. However, the programs may be implemented in an assembly or machine language, if desired. In any case, the language may be a compiled or interpreted language. Furthermore, the programs may be run on a programmed application-specific integrated circuit for this purpose.

Moreover, the operations of the processes described herein may be performed in any suitable order unless otherwise indicated herein or otherwise clearly contradicted by context. The processes described herein (or variations and/or combinations thereof) may be performed under control of one or more computer systems configured with executable instructions, and may be implemented by hardware, or combinations thereof, as codes (e.g., executable instructions, one or more computer programs, or one or more applications) executed collectively on one or more processors. The computer programs include a plurality of instructions executable by one or more processors.

Further, the method may be implemented in a computer operatively connected to any suitable computing platform including, but not limited to, a personal computer, a smartphone, a mainframe, a workstation, a networked or distributed computing environment, a stand-alone or integrated computer platform, or in communication with a charged particle tool or other imaging apparatus, etc. Aspects of the present disclosure may be implemented in a machine-readable code stored on a non-transitory storage medium or device, whether removable or integrated into a computing platform, such as a hard disk, an optically read and/or write storage medium, an RAM, and an ROM, so that it can be read by a programmable computer. When the storage medium or device is read by the computer, it can be used to configure and operate the computer to perform the processes described herein. In addition, the machine-readable codes, or portions thereof, may be transmitted over a wired or wireless network. The present disclosure described herein includes these and other different types of non-transitory computer-readable storage media when such media include instructions or programs that implement the steps described above in conjunction with a microprocessor or other data processor. The present disclosure also includes the computer itself when programmed according to the methods and techniques described herein.

The computer program can be applied to input data to perform the functions described herein to convert the input data to generate output data that are stored in a non-volatile memory. The output information may also be applied to one or more output devices such as displays. In a preferred embodiment of the present disclosure, the converted data represent physical and tangible objects, including specific visual presentations of the physical and tangible objects produced on the display.

While the embodiments of the present disclosure have been shown and described, it will be appreciated by a person of ordinary skill in the art that numerous changes, modifications, substitutions and variations can be made to these embodiments without departing from the principles and gist of the present disclosure, the scope of which is defined by the claims and their equivalents.

The preferred embodiments of the present disclosure have been specifically described above, but the present disclosure is not limited to the embodiments. A person of ordinary skill in the art may make various equivalent variations or substitutions without violating the spirit of the present disclosure. These equivalent transformations or substitutions shall all included in the scope defined by the embodiments.

1. A multi-task facial beauty prediction method, comprising:
acquiring a facial image;
training a multi-task teacher model according to the facial image to obtain a first model, wherein the multi-task teacher model comprises a shared feature network layer for extracting shared features and a plurality of independent feature network layers for extracting different specific features;
performing regularization on the first model according to a beauty grade label and a noise label of the facial image to obtain a second model;
performing cooperative teaching on a plurality of second models to obtain a target model parameter;
substituting the target model parameter into a multi-task student model to obtain a target model; and
performing facial beauty prediction processing using the target model to obtain a facial beauty prediction result.

2. The multi-task facial beauty prediction method according to claim 1, wherein the facial image comprises a plurality of types of facial beauty-related data; and the training a multi-task teacher model according to the facial image to obtain a first model comprises:
inputting the plurality of types of facial beauty-related data into the shared feature network layer for feature extraction to obtain shared features;
inputting the plurality of types of facial beauty-related data into the corresponding independent feature network layers for feature extraction to obtain a plurality of corresponding specific features; and
respectively inputting the shared features and the plurality of specific features into a plurality of task network layers of the multi-task teacher model to obtain a plurality of corresponding task output results to train the multi-task teacher model to obtain the first model.

3. The multi-task facial beauty prediction method according to claim 1, wherein the performing regularization on the first model according to a beauty grade label and a noise label of the facial image to obtain a second model comprises:
training the first model according to the facial image having the beauty grade label to obtain a basic model;
training the first model according to the facial image having the noise label to obtain a noise model;
reversely updating a parameter of the basic model according to a loss function of the noise model; and
performing regularization on the basic model with updated parameter to obtain the second model.

4. The multi-task facial beauty prediction method according to claim 3, wherein the performing regularization on the basic model with updated parameter to obtain the second model comprises:
adding a softmax layer to the basic model with updated parameter;
providing a layer weight value and a bias value to an output of the basic model to which the softmax layer is added;
performing dropout regularization on the output of the basic model to which the layer weight value and the bias value is provided to obtain a target output;
obtaining a target loss function of the basic model according to the target output and the first loss function; and
optimizing the parameter of the basic model according to the target loss function to obtain the second model.

5. The multi-task facial beauty prediction method according to claim 4, wherein the first loss function is a cross-entropy loss function.

6. The multi-task facial beauty prediction method according to claim 1, wherein the plurality of second models comprise two second models; and the performing cooperative teaching on a plurality of second models to obtain a target model parameter comprises:
determining first samples according to one of second networks, wherein the first samples are samples with a clean probability greater than a pre-set probability when the one of second networks performs feed-forward selection;
determining second samples according to the other one of the second networks, wherein the second samples are samples with a clean probability greater than a pre-set probability when the other one of the second networks performs feed-forward selection;
selecting third samples from the first samples according to a small loss criterion, wherein a proportion of the number of the third samples to the number of the first samples is a pre-set proportion;
selecting fourth samples from the second samples according to the small loss criterion, wherein a proportion of the number of the fourth samples to the number of the second samples is a pre-set proportion;
training the one of second networks via the fourth samples to obtain a first model parameter, and training the other one of the second networks via the third samples to obtain a second model parameter; and
obtaining a target model parameter according to the first model parameter and the second model parameter.

7. The multi-task facial beauty prediction method according to claim 6, wherein the pre-set proportion is related to a forgetting rate of the second models.

8. A facial beauty prediction apparatus, comprising:
an input unit, configured to acquire a facial image;
a model training unit, configured to train a multi-task teacher model according to the facial image to obtain a first model, wherein the multi-task model comprises a shared feature network layer for extracting shared features and a plurality of independent feature network layers for extracting different specific features;
a regularization unit, configured to perform regularization on the first model according to a beauty grade label and a noise label of the facial image to obtain a second model;
a cooperative teaching unit, configured to perform cooperative teaching on a plurality of second models to obtain a target model parameter, and to substitute the target model parameter into a multi-task student model to obtain a target model; and
a prediction unit, configured to perform facial beauty prediction processing using the target model to obtain a facial beauty prediction result.

9. An electronic device, comprising: a memory, a processor, and a computer program stored on the memory and executable on the processor, wherein the processor, when executing the computer program, implements the multi-task facial beauty prediction method according to claim 1.

10. A non-transitory computer-readable storage medium, wherein the computer-readable storage medium has computer-executable instructions stored thereon for performing the multi-task facial beauty prediction method according to claim 1.
